(19) United States
(12) Patent Application Publication
(10) Pub. No.: US 2024/0331672 A1
(43) Pub. Date: Oct. 3, 2024

(54) ELECTROMECHANICAL ACTUATOR FOR AN ACOUSTIC PIANO

(71) Applicant: Steinway Musical Instruments, Inc., Astoria, NY (US)

(72) Inventor: Robert Johnson, London (GB)

(21) Appl. No.: 18/128,787

(22) Filed: Mar. 30, 2023

(51) Int. Cl. G10H 3/22; G10C 3/26; G10H 1/00

(52) U.S. Cl. CPC G10H 3/22; G10C 3/26; G10H 1/0033

(57) ABSTRACT

An acoustic piano includes strings, a plurality of keys, a plurality of mechanical control members, a foot pedal mechanism kinematically connected to the plurality of mechanical control members, the foot pedal mechanism including a foot pedal configured to be manipulated to modulate an attribute of an audible output of the acoustic piano. The acoustic piano also includes at least one electromechanical actuator configured to be driven to move at least one mechanical control member, and a controller operably connected to the at least one electromechanical actuator. The controller is configured to receive a user-generated sensor signal and, in response to the user-generated sensor signal, generate at least one electrical signal to drive the at least one electromechanical actuator and thereby move the at least one mechanical control member to modulate the attribute.

### TECHNICAL FIELD

This specification relates to an electromechanical actuator for an acoustic piano.

### BACKGROUND

An acoustic piano is an instrument that can include piano keys, hammers, strings, and dampers. In response to input to the piano keys, a hammer physically hits the corresponding strings to create an audible output. Acoustic pianos typically include three foot-operated pedals: a soft pedal (sometimes referred to as an una corda pedal), a sostenuto pedal, and a sustain pedal (sometimes referred to as a damper pedal). In response to user input to the pedals, these pedals modulate the sound produced by the piano, for example, by moving dampers of the piano.

### SUMMARY

This disclosure describes an acoustic piano with an electromechanical actuator that modulates the sound produced by the piano without user input to the pedals. The electromechanical actuator can be connected to a controller that receives user input from an external sensor. The controller can generate an electrical signal that drives the electromechanical actuator and thereby allow a user to modulate the sound produced by the piano without interacting with the pedals.

In one aspect, an acoustic piano is featured. The acoustic piano includes strings, a plurality of keys operable to actuate the strings to cause the acoustic piano to emit an audible output, a plurality of mechanical control members movable relative to the strings, a foot pedal mechanism kinematically connected to the plurality of mechanical control members, the foot pedal mechanism comprising a foot pedal configured to be manipulated to modulate an attribute of the audible output, at least one electromechanical actuator configured to be driven to move at least one mechanical control member of the plurality of mechanical control members to modulate the attribute, and a controller operably connected to the at least one electromechanical actuator. The controller is configured to receive a user-generated sensor signal and, in response to the user-generated sensor signal, generate at least one electrical signal to drive the at least one electromechanical actuator and thereby move the at least one mechanical control member to modulate the attribute.

In another aspect, an acoustic piano is featured. The acoustic piano includes a plurality of keys operable to cause the acoustic piano to emit an audible output, a foot pedal mechanism comprising a foot pedal configured to be manipulated to modulate an attribute of the audible output, at least one electromechanical actuator configured to be driven to bypass the foot pedal mechanism to modulate the attribute, and a controller operably connected to the at least one electromechanical actuator. The controller is configured to receive a sensor signal indicative of a user action and, in response to the sensor signal, generate at least one electrical signal to drive the at least one electromechanical actuator and thereby modulate the attribute.

In another aspect, a method for operating an acoustic piano is featured. The method includes receiving, by one or more processing devices of the acoustic piano, a sensor signal indicative of a user action, and controlling, by the one or more processing devices and in response to the sensor signal, at least one electromechanical actuator of the acoustic piano to move at least one mechanical control member to modulate an attribute of an audible output emitted by the acoustic piano.

In some implementations, the method further includes: in a record mode of the acoustic piano, storing data indicative of actuation of the at least one mechanical control member while controlling the at least one electromechanical actuator of the acoustic piano, and in a playback mode of the acoustic piano, driving the at least one electromechanical actuator to move the at least one mechanical control member based on the data.

In some implementations, the method further includes: in a user play mode or in a record mode of the acoustic piano, disabling the at least one electromechanical actuator, and in response to activation of a user-assist mode while in the user play mode or the record mode, enabling the at least one electromechanical actuator. Controlling the at least one electromechanical actuator includes controlling the at least one electromechanical actuator while the user-assist mode is active in the user play mode or the record mode.

In some implementations, the foot pedal is configured to be manipulated to move the at least one mechanical control member to modulate the attribute.

In some implementations, the at least one mechanical control member includes a first mechanical control member of the plurality of mechanical control members, and the foot pedal is configured to be manipulated to move a second mechanical control member of the plurality of mechanical control members to modulate the attribute. In some implementations, the at least one electromechanical actuator includes a plurality of electromechanical actuators, the at least one mechanical control member includes at least two mechanical control members, the at least one electrical signal includes a plurality of electrical signals, and the controller is configured to receive the user-generated sensor signal and, in response to the user-generated sensor signal, generate the plurality of electrical signals to drive the plurality of electromechanical actuators and thereby move the at least two mechanical control members to modulate the attribute.

In some implementations, the acoustic piano further includes an external sensor configured to generate the user-generated sensor signal. In some implementations, the external sensor is any one of: a bite sensor, a head tilt sensor, a muscle twitch sensor, an eye tracking sensor, a movement sensor, a sip and puff switch, a pressure sensor, an eye blink sensor, a finger switch, a camera, a proximity sensor, or an audio sensor.

In some implementations, the controller is operably connected to the external sensor.

In some implementations, the controller is detachably connected to the external sensor. In some implementations, the controller is detachably connected to the external sensor through any one of: a TRS connector, or a TS connector.

In some implementations, the controller is configured to wirelessly communicate with the external sensor.

In some implementations, the acoustic piano includes dampers for engaging the strings. The at least one mechanical control member is movable to move the dampers into engagement with the strings.

In some implementations, the acoustic piano includes hammers configured to strike the strings in response to operation of the keys. The at least one mechanical control member is a shifter for shifting the hammers relative to the strings.

In some implementations, the acoustic piano is a player piano.

In some implementations, the controller is selectively operable in multiple player piano modes.

In some implementations, the multiple player piano modes include a record mode and a playback mode, and the controller is configured to: in the record mode, store data indicative of actuation of the at least one mechanical control member, and in the playback mode, drive the at least one electromechanical actuator to move the at least one mechanical control member based on the data.

In some implementations, the multiple player piano modes further include a user play mode, in the user play mode, the controller is configured to disable the at least one electromechanical actuator, and in the user play mode, the controller is further configured to enable the at least one electromechanical actuator, receive the user-generated sensor signal, and generate the at least one electrical signal to drive the at least one electromechanical actuator.

In some implementations, the controller is configured to, in the record mode, disable the at least one electromechanical actuator and store the data indicative of the actuation of the at least one mechanical control member.

In some implementations, the data is first data, and the controller is configured to: in a first operation in the record mode, disable the at least one electromechanical actuator and store the first data indicative of the actuation of the at least one mechanical control member as the foot pedal mechanism is actuated, and in a second operation in the record mode, enable the at least one electromechanical actuator and store second data indicative of actuation of the at least one mechanical control member as the at least one electromechanical actuator is actuated.

In some implementations, the controller is configured to receive the user-generated sensor signal and generate the at least one electrical signal in the second operation in the record mode.

In some implementations, the controller is further operable in a user-assist mode in which the at least one electromechanical actuator is enabled. The controller is configured to, in the user-assist mode, receive the user-generated sensor signal and, in response to the user-generated sensor signal, generate the at least one electrical signal.

In some implementations, the controller is configured to activate the user-assist mode in a record mode or a user play mode of the multiple player piano modes to enable the at least one electromechanical actuator.

In some implementations, the foot pedal mechanism includes a linkage kinematically connected to the foot pedal. The foot pedal is configured to be manipulated to drive the linkage to modulate the attribute.

In some implementations, the controller is configured to generate the at least one electrical signal to drive the at least one electromechanical actuator and thereby move the at least one mechanical control member without a user input on the foot pedal.

In some implementations, the at least one electromechanical actuator includes at least one of a solenoid, or a motor.

Advantages of the systems and methods described in this disclosure may include those described below and elsewhere in this disclosure.

Implementations described in this disclosure can provide users the ability to modulate the sound produced by an acoustic piano without interacting with the pedals, emulating the modulation of sound typically provided by user input to the pedals. In a typical acoustic piano, the pedals are connected to control members so that when a pedal is depressed by a user, the control member moves and modulates an attribute of the sound produced by the piano. An acoustic piano according to this disclosure can use a controller to receive input from an external sensor that receives input from a user that indicates they would like to modulate the sound produced by the piano. The controller can generate an electrical signal to drive an electromechanical actuator to move one or more control members, which modulates an attribute of the sound produced by the piano. Thus the acoustic piano can modulate the sound produced by the piano without relying on physical actuation or user input to the pedals.

An acoustic piano in accordance with implementations described in this disclosure can provide a user with a more flexible and inclusive playing experience. For example, on a typical acoustic piano, the pedals are positioned on the floor under the middle of the keyboard, and users of different sizes and physical abilities may find it difficult to reach pedals using their feet. The acoustic piano described in this disclosure can modulate sound in response to user input to an external sensor, which can be positioned in many locations relative to a user and activated in many different ways. Thus a user or users can choose where to position an external sensor and how to activate it, providing flexibility for modulating the sound produced by the piano, and providing the ability to modulate the sound produced by the piano to users that may have trouble physically interacting with pedals.

Implementations described in this disclosure can be adapted to many acoustic pianos. For example, an acoustic piano with electromechanical actuators such as a player piano can provide users the ability to modulate sound produced by the pianos without interacting with the pedals. A player piano can provide multiple modes of operation to a user, such as playback mode, user play mode, and record mode. In playback mode, the electromechanical actuators are typically enabled in order to move the control members to modulate the sound based on the previously recorded or saved pieces of music. In user play mode, the electromechanical actuators are typically disabled because a user can interact with the piano pedals. In record mode, the electromechanical actuators are typically disabled because a user can interact with the piano pedals.

An acoustic piano in accordance with implementations described in this disclosure can enable the electromechanical actuators in user play mode and record mode so that a user can use an external sensor to modulate the sound, rather than having to rely on the pedals. The implementations described in this disclosure can thus be adapted to appropriate player pianos that can receive input from an external sensor.

An acoustic piano in accordance with implementations described in this disclosure can provide the ability to modulate the sound produced by the piano to users in an easy-to-use user experience. For example, the acoustic piano can include a controller to receive user inputs from an external sensor. The controller can be configured to receive user inputs from the external sensor and generate electrical signals to drive an electromechanical actuator upon receiving a signal that an external sensor has been connected. The controller can also be connected to an interface that allows a user to select the pedal function that the external sensor mimics. The user can also use the interface to control the controller to select different pedal functions for different external sensors. Thus the acoustic piano can provide a simple and customizable user experience for enabling the electromechanical actuators.

An acoustic piano in accordance with implementations described in this disclosure can be easier and less costly to maintain than a typical acoustic piano. For example, typical acoustic pianos include only a physical pedal mechanism that can be difficult to maintain and repair. An acoustic piano with a controller and electromechanical actuators can mimic the result of pressing a physical pedal, so there is less maintenance required.

The details of one or more implementations of the subject matter described in this specification are set forth in the accompanying drawings and the description below. Other potential features, aspects, and advantages will become apparent from the description, the drawings, and the claims.

### BRIEF DESCRIPTION OF THE DRAWINGS

FIG. 1 is a front perspective view of an example acoustic piano.

FIG. 2 is a schematic diagram of an example mechanical system for producing an audible output for an acoustic piano.

FIG. 3 is a bottom horizontal cross-sectional view of an example acoustic piano.

FIG. 4 is a block diagram of a system of components in an example acoustic piano.

FIGS. 5A and 5B are front and front perspective views of an example electromechanical actuator.

FIG. 6 is a bottom view of an electromechanical actuator on an example acoustic piano.

FIG. 7 is a block diagram of modes of operation of an example acoustic piano.

FIG. 8 is a diagram of a process for bypassing the foot pedal mechanism in an example acoustic piano.

Like reference numbers and designations in the various drawings indicate like elements.

### DETAILED DESCRIPTION

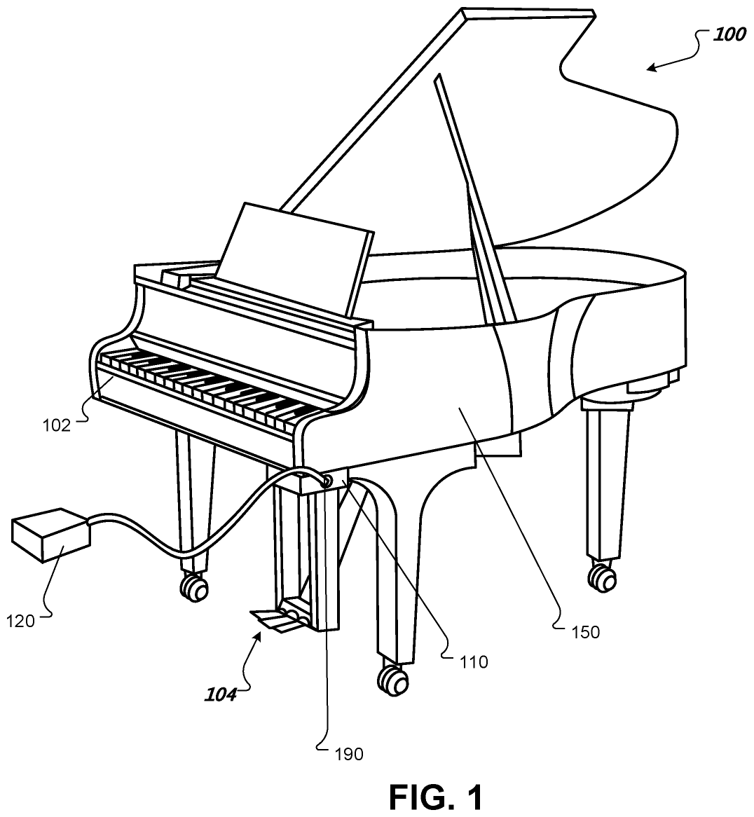

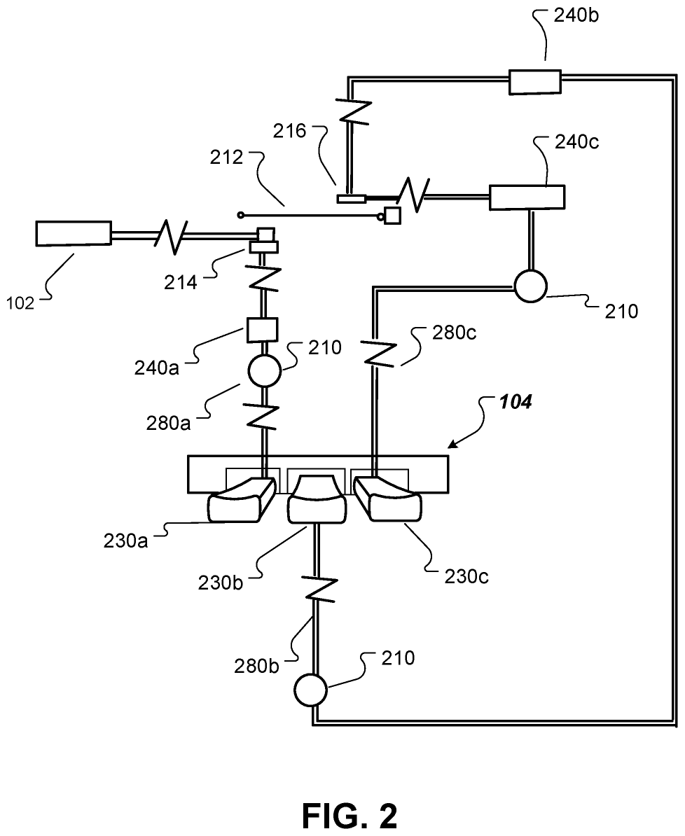

Referring to FIG. 1, an example of an acoustic piano 100 includes multiple keys 102, a foot pedal mechanism 104, a controller 110, and an external sensor 120. Referring to FIG. 2, the piano 100 also includes strings 212, hammers 214, dampers 216, one or more electromechanical actuators 210, and one or more mechanical control members (e.g., mechanical control members 240a, 240b, 240c, collectively referred to as mechanical control members 240). The keys 102 are operable to actuate the strings 212 using hammers 204 to cause the acoustic piano to emit an audible output. A mechanical control member, also referred to as control member, (e.g., one of the mechanical control members 240) is movable relative to the strings 212 to modulate an attribute of the audible output. The foot pedal mechanism 104 is kinematically connected to a control member 240. The electromechanical actuator 210 can be driven to move a control member to modulate the attribute of the audible output. In some implementations, multiple control members can be moved to modulate the attribute of the audible output, and each control member can be moved by a corresponding electromechanical actuator 210. The controller 110 is configured to receive a user-generated sensor signal from the external sensor 120 and generate an electrical signal to drive the electromechanical actuator 210. In some implementations, the controller 110 is configured to generate multiple electrical signals to drive multiple electromechanical actuators 210. As discussed in this disclosure, implementations of acoustic pianos operably connected with the external sensor can allow users to modulate attributes of the audible output without interacting with the foot pedal mechanism 104, providing for a more flexible and inclusive playing experience.

As shown in FIG. 1, the piano 100 can include keys 102 attached to an external surface of a piano housing 150. The piano housing 150 can include hammers 214, strings 212, and dampers 216 internally. Each key 102 can receive user input, for example, depressing a key or releasing a key. Each key 102 has a corresponding hammer 214, one or more strings 212, and a damper 216. Each hammer 214 can move relative to the corresponding one or more strings 212 and then strike the one or more strings 212 that correspond to a particular note, causing the one or more strings 212 to vibrate. The vibration of the one or more strings 212 produces audible output of that particular note. Each damper 216 can be moved relative to the one or more corresponding strings 212 to engage with the one or more corresponding strings 212. This engagement inhibits (e.g., prevents) vibration of the strings 212. Each damper 216 can be disengaged from the one or more corresponding strings 212, thereby allowing the strings 212 to vibrate. Each damper 216 can be in contact with a damper tray (e.g., a damper tray 240c in FIG. 2) and/or a damper rod (e.g., a damper rod 240b in FIG. 2). When the damper tray is operated (e.g., raised relative to the strings 212), multiple dampers (e.g., all of the dampers 216) can be disengaged from (e.g., simultaneously) the corresponding strings. When the damper rod is operated (e.g., raised relative to one or more of the strings 212), any individual damper 216 that was already disengaged from its corresponding strings 212 can remain disengaged, while the other dampers 216 remain engaged with their corresponding strings 212.

Upon a user pressing or operation of a key 102, the damper 216 disengages from the string 212 and the hammer 204 strikes the string 212, producing an audible output of a particular note. Upon a user releasing a key 102, the damper 216 is moved to engage with the string 212, preventing the string 212 from vibrating and preventing the particular note from continuing to sound.

The foot pedal mechanism 104 can include one or more pedals 230. As shown in FIG. 1, the foot pedal mechanism 104 can be attached externally to the piano housing 150. The foot pedal mechanism 104 is kinematically connected to mechanical control members 240 (shown in FIG. 2). Each pedal 230 is configured to be manipulated (e.g., depressed) to move a corresponding one of the mechanical control members 240 to modulate an attribute of the audible output. For example, the foot pedal mechanism 104 can include a linkage 280 kinematically connected to each foot pedal 230. Each foot pedal 230 is configured to be manipulated to drive the linkage 280 to move the corresponding mechanical control member.

The mechanical control member is movable relative to the strings 212 to modulate an attribute of the audible output. The mechanical control member can vary in implementations.

In some implementations, the mechanical control member can include the damper rod or sostenuto rod 240b. When actuated, the damper rod or sostenuto rod 240b is movable relative to the strings to move a damper 216 into engagement with the strings. The damper rod or sostenuto rod 240b can contact an individual damper 216 that is disengaged from its corresponding one or more strings 212 such that movement of the damper rod or sostenuto rod 240b causes the individual damper 216 to remain disengaged from the strings.

In some implementations, the mechanical control member can be the damper tray 240c. When actuated, the damper tray 240c can be movable relative to the strings to move multiple dampers (e.g., all of the dampers 216) away from the strings, thereby disengaging the multiple dampers from the strings. The damper tray 240c can contact each of the multiple dampers such that movement of the damper tray 240c causes corresponding movements of the multiple dampers away from the strings.

In some implementations, the mechanical control member can be a shifter 240a. When actuated, the shifter 240a shifts each key 102 and hammer 204 relative to the corresponding strings 212, e.g., by moving the keys 102 and hammers 204 away from the corresponding strings 212.

Upon user input to or operation of one of the pedals 230, the pedal 230 is manipulated to move the control member 240 to modulate the attribute of the audible output. For example, the foot pedal mechanism 104 includes three pedals 230: a soft pedal 230a (sometimes referred to as an una corda pedal), a sostenuto pedal 230b, and a sustain pedal 230c (sometimes referred to as a damper pedal). The attribute that is modulated can include the tone quality, strength, and duration of notes in the audible output, for example. Modulation of an attribute can occur before the audible output is generated, for example, using the soft pedal 230a, or during or after the audible output is generated, for example, using the sostenuto pedal 230b or damper pedal 230c.

The soft pedal 230a modifies the tone quality and strength of notes. The soft pedal 230a can be kinematically connected to linkage 280a. When the soft pedal 230a is depressed, the soft pedal 230a can drive linkage 280a to move the shifter 240a, thereby shifting each hammer 204 relative to the corresponding strings 212. When a user presses a key 102, the corresponding hammer 204 strikes fewer of the corresponding strings 212. For some keys 102, the corresponding hammer 204 strikes corresponding strings 212 at a different part of the hammer 204. The soft pedal 230a thus modifies the tone quality and strength of the notes corresponding to keys 102 that are pressed while the soft pedal 230a is depressed or in operation. When the soft pedal 230a is released, the soft pedal 230a can drive linkage 280a to move the shifter 240a so that each hammer 204 shifts back to its original location relative to the corresponding strings 212.

The sostenuto pedal 230b selectively sustains note(s) from keys that are pressed at the time of the sostenuto pedal 230b being depressed. The sostenuto pedal 230b can be kinematically connected to linkage 280b. When the sostenuto pedal 230b is depressed, the sostenuto pedal 230b can drive linkage 280b to move damper rod 240b. For example, when a user presses a key 102, the corresponding damper 216 is raised. When the sostenuto pedal 230b is depressed, the damper rod 240b is raised so that the damper 216 remains disengaged from the string 212. Thus the note corresponding to key 102 is sustained, while other keys that are played while the sostenuto pedal 230b is depressed are not. When the sostenuto pedal 230b is released, the sostenuto pedal 230b can drive linkage 280b to move the damper rod 240b so the raised damper 216 is moved into engagement with the strings 212.

The damper pedal 230c causes all notes to be sustained as long as the damper pedal 230c is depressed, producing a “sympathetic resonance” effect. The damper pedal 230c can be kinematically connected to linkage 280c. When the damper pedal 230c is depressed, the damper pedal 230c can drive linkage 280c to move damper tray 240c that can be raised relative to the strings 212 to disengage all of the dampers 216 from the strings 212. Thus after a user releases a key 102, the dampers 216 do not move back into engagement with the string 212. When the damper pedal 230c is released, the damper pedal 230c can drive linkage 280c to lower the damper tray 240c so that all of the dampers 216 are moved into engagement with the strings 212.

Other pedal types can instead or additionally be included, such as muffling pedals. In some implementations, the foot pedal mechanism 104 includes another number of piano pedals, e.g., one piano pedal, two piano pedals, or more than three piano pedals.

The acoustic piano 100 includes electromechanical systems to allow the mechanical control members 240 to be actuated without use of the foot pedal mechanism 104. The electromechanical systems can include, in addition to or in place of the foot pedals 230, the electromechanical actuators 210. The electromechanical actuators 210 can be driven to bypass the foot pedal mechanism 104, allowing a user to modulate an attribute of the audible output without having to interact with the foot pedals 230 and providing the user with a more inclusive and flexible playing experience. For example, the electromechanical actuators 210 can be driven to move the control members 240 in the same manner that a foot pedal 230 being depressed would drive a linkage 280 to move a control member 240 to modulate an attribute.

In some implementations, the electromechanical actuators 210 can be driven to move different control members than the control member that the foot pedal 230 moves to modulate the attribute. For example, the sostenuto pedal 230b can drive the linkage 280b to move a control member, damper rod 240b, to modulate the attribute of note duration. The electromechanical actuators 210 can be driven to move control members 240 connected to each individual damper 216, rather than damper rod 240b, to mimic the sostenuto pedal. For example, each damper 216 can be connected to a control member, and each of these control members can be connected to an electromechanical actuator 210. The electromechanical actuators 210 can be driven to move the control members to modulate the same attribute that the sostenuto pedal modulates.

The electromechanical actuator 210 is connected to the control member 240 and the controller 110. The electromechanical actuator 210 vary in implementations. In some implementations, the electromechanical actuator 210 is a solenoid that is driven by an electrical current (e.g., supplied by a power supply) to cause movement of a plunger, which in turn causes movement of a mechanical control member. In some implementations, the electromechanical actuator 210 is a motor that is driven by electrical energy (e.g., supplied by a power supply) to cause movement of an actuator, which in turn causes movement of a mechanical control member. In some implementations, the electromechanical actuator 210 is driven by an electrical current to generate a magnetic field that causes movement of an actuator, which in turn causes movement of a mechanical control member. The electromechanical actuator 210 can be operated by an electrical signal from the controller 110, as discussed below.

The controller 110 can be located on the piano 100. For example in FIG. 1, the controller 110 is located in the portion of the piano 100 below the keys 102.

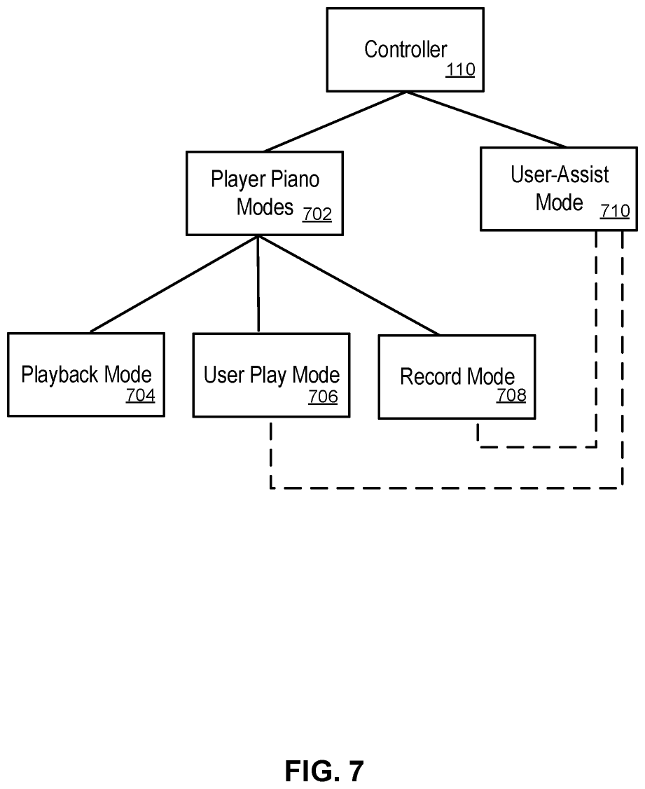

In some implementations, the piano 100 can be a player piano and the controller 110 can be operable in different modes, as discussed below with reference to FIG. 7.

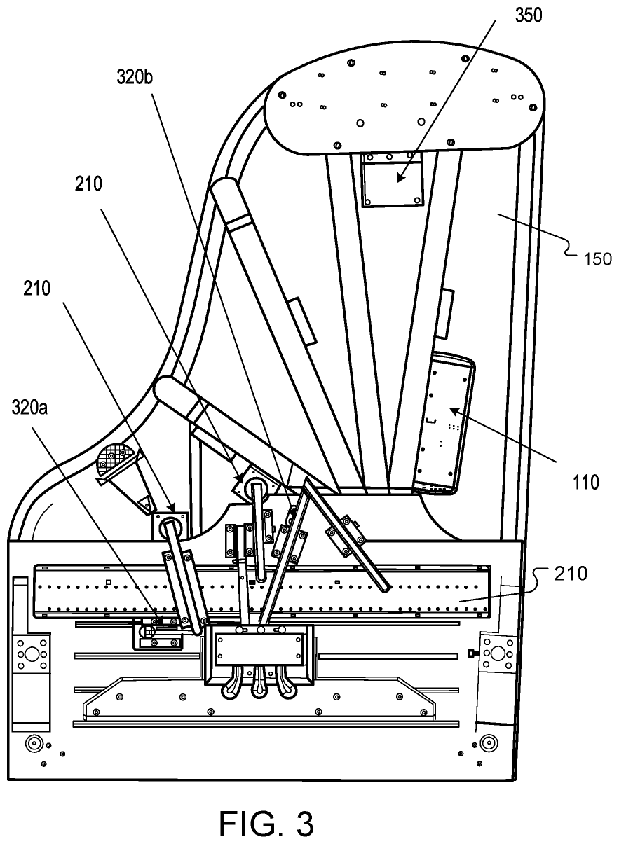

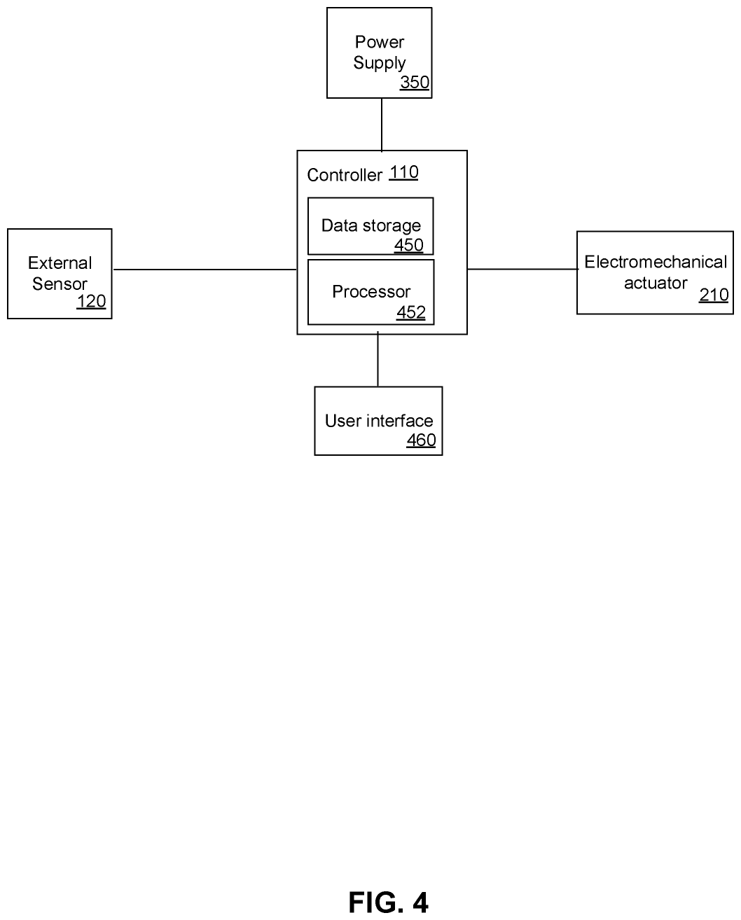

Referring to FIGS. 3-4, the controller 110 is connected to a power supply 350. The controller 110 can receive power from power supply 350.

The controller 110 includes a data storage 450 and a processor 452. The controller 110 can store data representing music pieces in data storage 450. The controller 110 can receive data representing music pieces from a user interface 460, or be configured to generate the data representing music pieces from signals from sensors 320.

The controller 110 can use the processor 452 to receive and process signals from sensors 320, user interface 460, and external sensor 120. The processor 452 can also enable or disable electromechanical actuator 210 and generate electrical signals that drive electromechanical actuator 210. In some implementations, the processor 452 can generate multiple electrical signals that drive multiple electromechanical actuators 210.

The controller 110 can be operably connected to sensors 320. Sensors 320 generate signals that represent the movement of control members 240 (driven by a pedal 230 or an electromechanical actuator 210, for example). For example, referring to FIG. 3, the sensors 320 include sensors 320a and 320b. For example, the sensor 320a can generate a signal indicative of movement of the shifter 240a. Sensor 320b can generate a signal indicative of movement of the damper rod 240b, or in some implementations, if a damper 216 has moved. Another sensor (not pictured) can generate a signal that represents that the damper tray 240c has moved. The controller 110 can use processor 452 to receive these signals and store data representing the signals in data storage 450.

The controller 110 can be operably connected to the user interface 460 (e.g., buttons or a panel on the piano 100) that allows a user to select options for the external sensor 120. In some implementations, the controller 110 and the user interface 460 can communicate with one another wirelessly.

The controller 110 can be operably connected to an external sensor 120. In some implementations, the controller 110 is detachably connected to the external sensor 120. For example, the controller 110 can be connected to the external sensor 120 through a tip-ring-sleeve (TRS) connector or tip-sleeve (TS) connector 190. In some implementations, the controller 110 can wirelessly communicate with the external sensor 120. For example, the controller 110 can receive signals from external sensor 120 over one or more wireless networks such as a Bluetooth network or a Wi-Fi network.

The external sensor 120 is configured to generate a sensor signal in response to a user input. The external sensor 120 can be positioned near the user so that the external sensor 120 can generate sensor signals in response to physical input with the user, audio input from the user, or visual input from the user. The external sensor 120 can be positioned in many locations and orientations relative to the user, providing a user with a more flexible playing experience. For example, the external sensor 120 can be positioned so that users who have trouble interacting with the foot pedal mechanism 104 can more easily interact with the external sensor 120 to modulate the sound.

The external sensor 120 can be responsive to a physical input by the user. The external sensor 120 can be, for example, a bite sensor (e.g., responsive to a bite action taken by the user), a head tilt sensor (e.g., responsive to movement of a head of the user), a muscle twitch sensor (e.g., responsive to a muscle contraction by the user), an eye tracking sensor (e.g., responsive to movement of an eye of the user), a movement sensor (e.g., responsive to movement of the user), a sip and puff switch (e.g., responsive to an inhale and/or exhale of the user), a pressure sensor (e.g., responsive to a pressure applied by the user), an eye blink sensor (e.g., responsive to a blink action taken by the user), a finger switch (e.g., responsive to a touch action taken by the user), a camera (e.g., responsive to an action taken by the user that results in a visual cue), a proximity sensor (e.g., responsive to a presence of the user within a certain range), or an audio sensor (e.g., responsive to a sound produced by the user that results in an audible cue). In some implementations, multiple external sensors such as external sensor 120 can be positioned near the user and configured to generate sensor signals in response to user inputs. The variety of external sensors 120 and their different user inputs can provide a user with a more flexible playing experience.

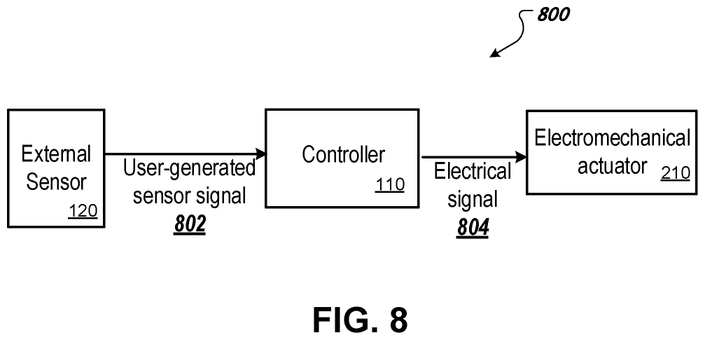

The external sensor 120 is connected to the controller 110. When the controller 110 receives a signal from the external sensor 120 representing a user input, the controller 110 can generate an electrical signal to drive electromechanical actuator 210, as discussed below with reference to FIG. 8.

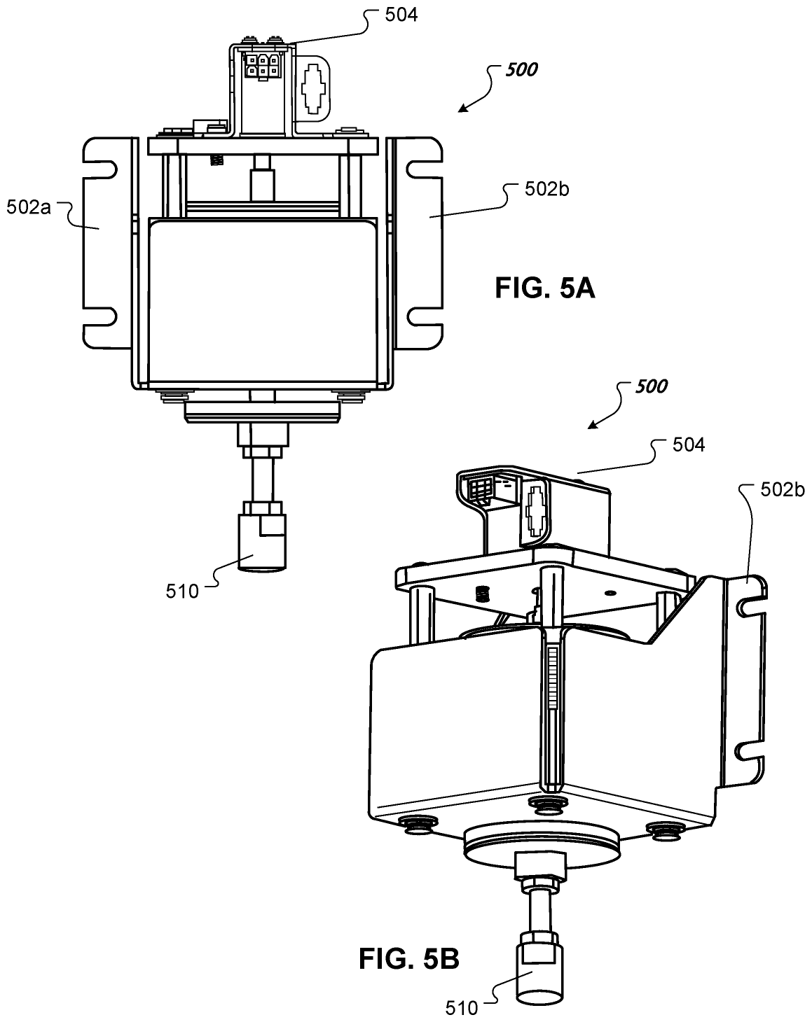

FIGS. 5A-5B show an example of the electromechanical actuator. In the example shown in FIGS. 5A-5B, the electromechanical actuator is a solenoid 500. The solenoid 500 is an example of the electromechanical actuator 210 that can be configured to be driven to bypass the foot pedal mechanism 104 to modulate an attribute of the audible output of piano 100.

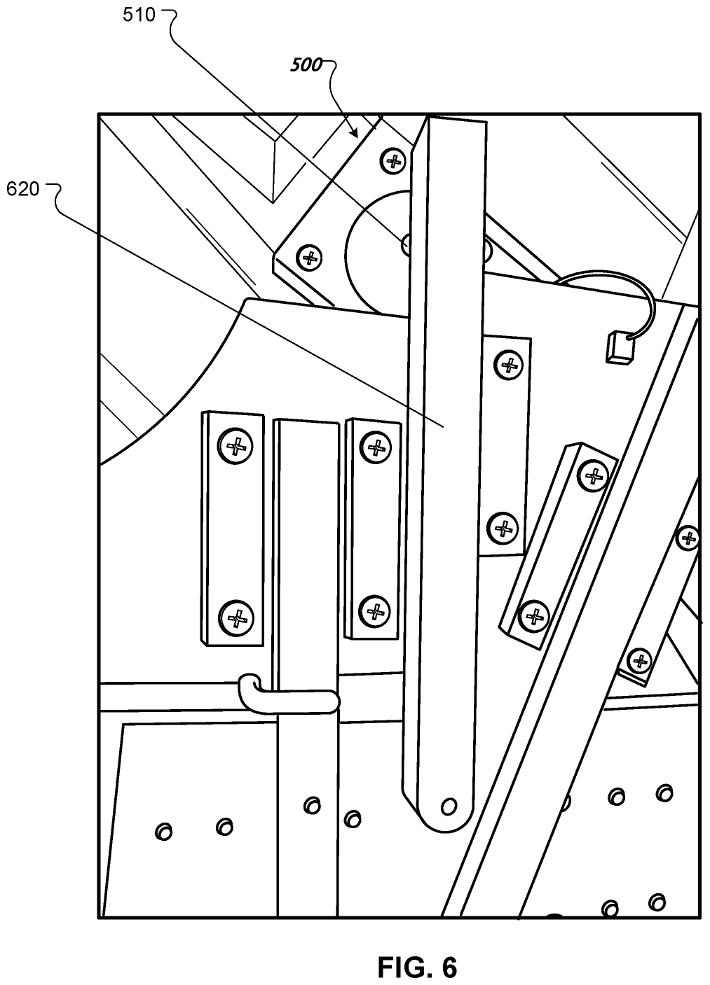

The solenoid 500 is mounted to the inside or bottom of the piano housing 150 using mounting elements 502a, 502b, and 504. For example, the solenoid 500 can be mounted to piano 100 as shown in FIG. 6.

The solenoid 500 is connected to the power supply 350 and receives power from power supply 350. The solenoid is also connected to the controller 110 and receives electrical signals from controller 110.

The solenoid 500 includes an actuator 510 (e.g., a plunger). When the solenoid 500 is driven, the actuator 510 can extend or retract out of the solenoid 500. The actuator 510 can be connected to a mechanical control member (e.g., one of the mechanical control members 240 described in this disclosure). Thus when the solenoid 500 is driven, the control member 240 moves.

The actuator 510 can be connected to a control member 240 directly or through other mechanical components such as levers that are connected to a control member 240. For example, referring to FIG. 6, the actuator 510 is connected to a bar 620. The bar 620 could be control member 240 itself. In some implementations, the bar 620 could be connected to a control member 240. For example, the actuator 510 can move the bar 620 which in turn moves a damper bar, damper tray, one or more dampers, or shifter.

Referring to FIG. 7, the piano 100 can be a player piano, e.g., the controller 110 can be selectively operable in multiple player piano modes 702. For example, the controller 110 can be operable in a user play mode 706, a record mode 708, and a playback mode 704.

In user play mode 706, the player piano can be played like a typical acoustic piano. The controller 110 typically disables the electromechanical actuators 210 because a user can interact with the piano pedals.

In record mode 708, the player piano can be played like a typical piano. In response to being played in record mode 708, the player piano records user inputs to the keyboard and the pedal for saving or later playback. For example, the controller 110 can receive signals from sensors 320 that are indicative of actuation of a control member 240. The controller 110 can store data in data storage 450 that is indicative of actuation of the control member 240. For example, the controller 110 can store data indicative of actuation of a control member while controlling the electromechanical actuator 210, or data indicative of actuation of a control member by actuating the foot pedal mechanism. The controller 110 typically disables the electromechanical actuators 210 because a user can interact with the piano pedals to actuate the control members 240.

In playback mode 704, the player piano plays back previously recorded pieces or previously saved pieces of music. For example, the data representing the previously recorded pieces can be generated in record mode 708. The controller 110 can then access data representing the previously recorded pieces from data storage 450 and process the data using processor 452 in order to generate electrical signals that drive electromechanical actuators to produce audible output or modulate the audible output. For example, each key can have a corresponding electromechanical actuator that can be driven to operate (e.g., lower into a pressed position, hold in the pressed position, or raise the key to release) the key without user input to the key. The controller 110 can thus generate electrical signals to drive the electromechanical actuators to produce audible output according to the data in data storage 450. In addition, the controller 110 can generate electrical signals that drive the electromechanical actuators 210. The controller 110 typically enables the electromechanical actuators 210 so that the electromechanical actuators 210 can move the control members to modulate the attribute of the audible output based on the data representing previously recorded or saved pieces of music.

The controller 110 can also be operable in a user-assist mode 710. The user-assist mode 710 can be activated in the user play and record modes. Generally, the user-assist mode 710 allows an external sensor such as external sensor 120 to be used. As described in greater detail with respect to FIG. 8, the user-assist mode 710 can be used for modulating an attribute of the audible output without user input to the pedals. The user-assist mode 710 can be activated on any appropriate acoustic piano with electromechanical actuators and that can receive input from an external sensor, such as a player piano.

FIG. 8 illustrates an example process 800 for using an external sensor for controlling an electromechanical actuator. In particular, in this process, the external sensor 120, controller 110, and electromechanical actuator 210 can be used to bypass the foot pedal mechanism 104 to modulate an attribute of the audible output of a piano.

The external sensor 120 generates a sensor signal, user-generated sensor signal 802, in response to a user input to the external sensor 120. The external sensor 120 transmits the user-generated sensor signal 802 to controller 110. The user-generated sensor signal 802 is indicative of a user action. For example, the user-generated sensor signal 802 can be binary, e.g., a pressure sensor can generate a user-generated sensor signal 802 that indicates the user is applying pressure. The user-generated sensor signal 802 can also be continuous, e.g., a pressure sensor can generate a user-generated sensor signal 802 that indicates a degree or magnitude of the pressure being applied by the user.

The controller 110 receives the user-generated sensor signal 802. The controller 110 processes the user-generated sensor signal 802, for example, by generating an electrical signal 804 for the electromechanical actuator 210 that corresponds to the external sensor 120. The controller 110 can transmit the electrical signal 804 to the electromechanical actuator 210.

The electrical signal 804 drives the electromechanical actuator 210 to modulate the attribute of the audible output. For example, the electromechanical actuator 210 can move a control member to modulate the attribute of the audible output. As described elsewhere in this disclosure, the control member that is moved can vary in implementations, and the attribute of the audible output that is modulated can vary in implementations.

In implementations where the controller is operable in user-assist mode, the controller 110 can enable the electromechanical actuator 210, and the external sensor 120, controller 110, and electromechanical actuator 210 can perform the process of FIG. 8 in the user-assist mode. For example, the controller 110 can operate in user-assist mode when a user controls the controller 110 (e.g., through a user interface) to activate user-assist mode. In some implementations, the controller 110 can operate in user-assist mode upon receiving a signal that an external sensor has been connected to the controller 110, e.g., through a can bus transmitter. The controller 110 can deactivate user-assist mode when a user controls the controller 110 to de-activate user-assist mode, or the controller 110 receives a signal that an external sensor has been disconnected. Thus, the user can easily activate and de-activate the user-assist mode.

In implementations where the controller is operable in user play mode and record mode, the controller can also simultaneously operate in user-assist mode. For example, in the user play mode, the controller 110 can enable the electromechanical actuator 210, receive the sensor signal 802, and generate the electrical signal 804 to drive the electromechanical actuator 210.

In the record mode, the controller 110 can also enable the electromechanical actuator 210, receive the sensor signal 802, and generate the electrical signal 804 to drive the electromechanical actuator 210. For example, rather than disabling the electromechanical actuator 210 and storing data indicative of the actuation of the control member as the foot pedal mechanism is actuated, the controller can enable the electromechanical actuator 210 and store data indicative of the actuation of the control member as the electromechanical actuator 210 is actuated.

Methods of modulating an attribute of the audible output of a piano using an external sensor can vary in implementations. For example, the controller 110 can be controlled (e.g., using a user interface) to select which foot pedal the external sensor 120 mimics. In implementations where the controller 110 is connected to multiple external sensors 120, the controller 110 can be controlled to select which foot pedal each external sensor 120 corresponds to. In some implementations, the controller 110 can be controlled to select the type of modulation or degree of modulation of an attribute, or the type of attribute, of the audible output. For example, the controller 110 can be used to select whether a signal from an external sensor 120 should be interpreted by the controller 110 as binary (e.g., the modulation is on or off), or continuous (e.g., a degree of modification of the audible output changes as the signal from the external sensor 120 changes). The controller 110 can thus provide a customizable user experience for using the external sensor 120 to modulate an attribute of the audible output.

A number of implementations have been described. While this specification contains many specific implementation details, these should not be construed as limitations on the scope of what is being claimed, which is defined by the claims themselves, but rather as descriptions of features that may be specific to particular implementations of particular inventions. It will be understood that various modifications may be made.

The subject matter and the actions and operations described in this specification (e.g., the process 800) can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus (e.g., the controller 110). The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Accordingly, other implementations are within the scope of the claims.

What is claimed is:

1. An acoustic piano comprising:
strings;
a plurality of keys operable to actuate the strings to cause the acoustic piano to emit an audible output;
a plurality of mechanical control members movable relative to the strings;
a foot pedal mechanism kinematically connected to the plurality of mechanical control members, the foot pedal mechanism comprising a foot pedal configured to be manipulated to modulate an attribute of the audible output;
at least one electromechanical actuator configured to be driven to move at least one mechanical control member of the plurality of mechanical control members to modulate the attribute; and
a controller operably connected to the at least one electromechanical actuator, wherein the controller is configured to receive a user-generated sensor signal and, in response to the user-generated sensor signal, generate at least one electrical signal to drive the at least one electromechanical actuator and thereby move the at least one mechanical control member to modulate the attribute.

2. The acoustic piano of claim 1, wherein the foot pedal is configured to be manipulated to move the at least one mechanical control member to modulate the attribute.

3. The acoustic piano of claim 1, wherein the at least one mechanical control member comprises a first mechanical control member of the plurality of mechanical control members, and the foot pedal is configured to be manipulated to move a second mechanical control member of the plurality of mechanical control members to modulate the attribute.

4. The acoustic piano of claim 3, wherein:
the at least one electromechanical actuator comprises a plurality of electromechanical actuators,
the at least one mechanical control member comprises at least two mechanical control members,
the at least one electrical signal comprises a plurality of electrical signals, and
the controller is configured to receive the user-generated sensor signal and, in response to the user-generated sensor signal, generate the plurality of electrical signals to drive the plurality of electromechanical actuators and thereby move the at least two mechanical control members to modulate the attribute.

5. The acoustic piano of claim 1, further comprising an external sensor configured to generate the user-generated sensor signal.

6. The acoustic piano of claim 5, wherein the external sensor is any one of: a bite sensor, a head tilt sensor, a muscle twitch sensor, an eye tracking sensor, a movement sensor, a sip and puff switch, a pressure sensor, an eye blink sensor, a finger switch, a camera, a proximity sensor, or an audio sensor.

7. The acoustic piano of claim 5, wherein the controller is operably connected to the external sensor.

8. The acoustic piano of claim 1, comprising dampers for engaging the strings, wherein the at least one mechanical control member is movable to move the dampers into engagement with the strings.

9. The acoustic piano of claim 1, comprising hammers configured to strike the strings in response to operation of the keys, wherein the at least one mechanical control member is a shifter for shifting the hammers relative to the strings.

10. The acoustic piano of claim 1, wherein the controller is selectively operable in multiple player piano modes.

11. The acoustic piano of claim 10, wherein the multiple player piano modes comprise a record mode and a playback mode, and the controller is configured to:
in the record mode, store data indicative of actuation of the at least one mechanical control member; and
in the playback mode, drive the at least one electromechanical actuator to move the at least one mechanical control member based on the data.

12. The acoustic piano of claim 11, wherein:
the multiple player piano modes further comprise a user play mode,
in the user play mode, the controller is configured to disable the at least one electromechanical actuator, and
in the user play mode, the controller is further configured to enable the at least one electromechanical actuator, receive the user-generated sensor signal, and generate the at least one electrical signal to drive the at least one electromechanical actuator.

13. The acoustic piano of claim 11, wherein the controller is configured to, in the record mode, disable the at least one electromechanical actuator and store the data indicative of the actuation of the at least one mechanical control member.

14. The acoustic piano of claim 11, wherein the data is first data, and the controller is configured to:
in a first operation in the record mode, disable the at least one electromechanical actuator and store the first data indicative of the actuation of the at least one mechanical control member as the foot pedal mechanism is actuated; and
in a second operation in the record mode, enable the at least one electromechanical actuator and store second data indicative of actuation of the at least one mechanical control member as the at least one electromechanical actuator is actuated.

15. The acoustic piano of claim 14, wherein the controller is configured to receive the user-generated sensor signal and generate the at least one electrical signal in the second operation in the record mode.

16. The acoustic piano of claim 10, wherein the controller is further operable in a user-assist mode in which the at least one electromechanical actuator is enabled,
wherein the controller is configured to, in the user-assist mode, receive the user-generated sensor signal and, in response to the user-generated sensor signal, generate the at least one electrical signal.

17. The acoustic piano of claim 1, wherein the foot pedal mechanism comprises a linkage kinematically connected to the foot pedal, and wherein the foot pedal is configured to be manipulated to drive the linkage to modulate the attribute.

18. The acoustic piano of claim 1, wherein the controller is configured to generate the at least one electrical signal to drive the at least one electromechanical actuator and thereby move the at least one mechanical control member without a user input on the foot pedal.

19. An acoustic piano comprising:
a plurality of keys operable to cause the acoustic piano to emit an audible output;
a foot pedal mechanism comprising a foot pedal configured to be manipulated to modulate an attribute of the audible output;
at least one electromechanical actuator configured to be driven to bypass the foot pedal mechanism to modulate the attribute; and
a controller operably connected to the at least one electromechanical actuator, wherein the controller is configured to receive a sensor signal indicative of a user action and, in response to the sensor signal, generate at least one electrical signal to drive the at least one electromechanical actuator and thereby modulate the attribute.

20. A method for operating an acoustic piano, the method comprising:
receiving, by one or more processing devices of the acoustic piano, a sensor signal indicative of a user action; and
controlling, by the one or more processing devices and in response to the sensor signal, at least one electromechanical actuator of the acoustic piano to move at least one mechanical control member to modulate an attribute of an audible output emitted by the acoustic piano.
